(19) United States
(12) Patent Application Publication
(10) Pub. No.: US 2004/0091722 A1
(43) Pub. Date: May 13, 2004

(54) Decorative metal composite panal

(76) Inventors: Meng Chen, Jiangxi Province (CN); Qingyun Wei, Jiangxi Province (CN)

Correspondence Address: BROWDY AND NEIMARK, P.L.L.C., 624 NINTH STREET, NW, SUITE 300, WASHINGTON, DC, 20001-5303, US

(21) Appl. No.: 10/473,229

(22) PCT Filed: Apr. 3, 2001
(86) PCT No.: PCT/CN02/00230

(30) Foreign Application Priority Data
Apr. 3, 2001 (CN) 01220703.9

(51) Int. Cl. B32B 15/04; B32B 3/26

(52) U.S. Cl. 428/457; 428/304.4

(57) ABSTRACT

A decorative composite metal panel being of a laminate structure, comprising a baseplate made of thin metal sheet; a faceplate made of thin metal sheet and provided with a decorative film on a surface thereof; an intermediate plate disposed between the baseplate and the faceplate and being of one or a plurality of layers; and adhesive layers provided between the baseplate and the intermediate plate and between the faceplate and the intermediate plate, respectively. The advantageous technical effects thereof are that: the design is novel and has a decorative surface of resin varnish type applied by rolling coating process; the structure is reasonable; the coat is smooth, having no chromatic aberration, and having better decorativeness, the panel has improved specific strength, specific rigidity, and sound and heat insulation performance, so that it can be used widely in construction industry, decoration, machinery, furniture and municipal engineering, etc.

### FIELD OF THE INVENTION

The present invention relates to a decorative laminate product substantively made of metal, especially to a decorative composite metal panel having porous intermediate plates.

### BACKGROUND ART

The existing thick metal panel, such as a steel panel having thickness of 4 mm or more, can not be provided with a decorative surface of resin varnish type using a rolling coating process due to limit of its thickness. A conventional spray coating process has disadvantages in that the utilization rate of the coating material is low and the operation environment is adverse, especially in that smoothness and chromatic aberration of coats are difficult to be controlled. In addition, the weight of a panel is larger and the sound insulation and heat insulation performance are poor.

### SUMMARY OF THE INVENTION

In view of this current state of the art, an motivation for research of the present invention is to provide a laminate structure, in which a surface layer of the laminate structure is advantageous to decoration and can exhibit a noble quality of the metal layer, and intermediate plates thereof can reduce weight of the structure and isolate sound, so that a panel having good aesthetic property and performance is obtained.

The present inventor proposes a novel structure of the present invention based on practical experience in research, manufacture and machining of various decoration materials.

Accordingly, an object of the present invention is to provide a decorative composite metal panel having good performance and decorativeness.

The present invention is achieved by providing a decorative composite metal panel, which having a laminate structure, comprising a baseplate made of thin metal sheet; a faceplate made of thin metal sheet, the faceplate being provided with a decorative film on a surface thereof; an intermediate plate disposed between the baseplate and the faceplate and being of one or a plurality of layers, and adhesive layers being provided between the baseplate and the intermediate plate and between the baseplate and the intermediate plate respectively. The decorative film is applied by rolling coating process.

Preferably, the adhesive layer is a hot melt film. The intermediate plate is provided with holes. The holes are preferably vertical holes. The holes are provided uniformly on the intermediate plate. The porosity of the holes is 30%-90%. The baseplate and the faceplate are formed by thin metal sheet, and the intermediate plate is made of metal sheet or thermoplastic resin sheet.

Preferably, the thickness of the thin metal sheet forming the baseplate and the faceplate is 0.08-1.00 mm, the intermediate plate is formed by a thin metal sheet having a thickness of 0.08-2.00 mm or thermoplastic resin sheet having a thickness of 1.5-6.0 mm. The vertical holes provided uniformly on the intermediate plate are circular, each of the holes has a diameter of 1.0-5.0 mm. The distance between centers of arbitrarily two adjacent circular holes is within a range of 1.5-6.0 mm. The surface of the baseplate can be also provided with a decorative film so that a decorative composite metal panel having decorative films on both surfaces thereof is obtained.

The present invention has the following advantageous technical effects: the design is novel and has a decorative surface of resin varnish type applied by rolling coating process; the structure is reasonable; the coating is smooth, having no chromatic aberration, and having better decorativeness. The porosity of the intermediate is large so that consumption of the materials and weight of the intermediate plate are reduced, thus having improved specific strength, specific rigidity, and sound and heat insulation performance. Therefore, the panel of the present invention can be used widely in construction industry, decoration, machinery, furniture and municipal engineering, etc.

### BRIEF DESCIRPTION OF THE DRAWINGS

Further advantages, features and details of the invention are explained in the following with the aid of preferred embodiments with reference to the drawings, in which:

FIG. 1 is a cross-sectional view schematically showing the structure of an embodiment of the present invention;

FIG. 2 is a cross-sectional partial view of the structure of an embodiment of the present invention, only showing one hole of the intermediate plate.

### DETAILED DESCRIPTION OF THE INVENTION

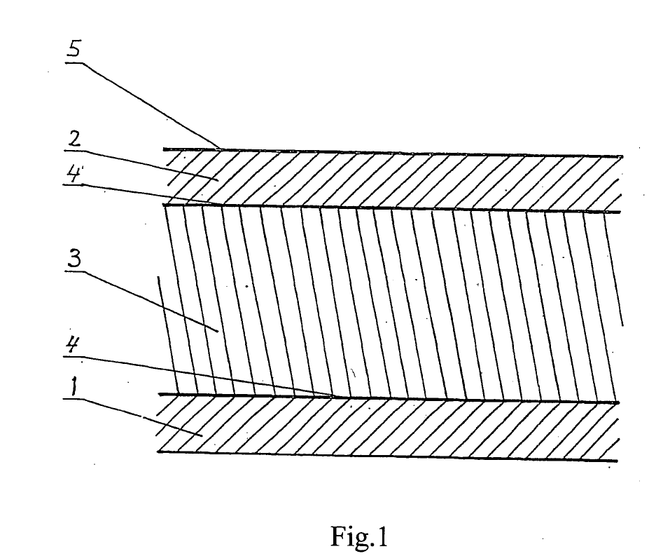

With reference to FIG. 1, a decorative composite metal panel according to a first embodiment of the present invention is explained as follow. The decorative composite metal panel of the first embodiment is of a laminate structure, comprising a baseplate 1 and a faceplate 2, the baseplate 1 and the faceplate 2 are formed by coiled sheet of aluminum having a thickness of 0.15 mm, an intermediate plate 3 formed by coiled sheet of steel having a thickness of 0.5 mm is provided between the baseplate 1 and the faceplate 2, hot melt films 4 used as adhesive are provided between the baseplate 1 and the intermediate plate 3 and between the baseplate 1 and the intermediate plate 3 respectively, a decorative film 5 of resin varnish type is provided on a surface of the faceplate 2 through rolling coating process. In this embodiment, the baseplate 1 and the faceplate 2 are formed by coiled sheet of aluminum having a thickness of 0.15 mm, and having good corrosion resistance and plasticity. The intermediate plate 3 is formed by coiled sheet of steel having a thickness of 0.5 mm, and having high impact strength, hardness and flexibility. This resultant laminate composite panel has advantages over a single layer aluminum panel having identical thickness therewith in performance.

Also, referring to FIG. 1, a decorative composite metal panel according to a second embodiment of the present invention is explained. The decorative composite metal panel of the second embodiment is of a laminate structure, comprising a baseplate 1 and a faceplate 2, the baseplate 1 and the faceplate 2 are formed by coiled sheet of aluminum having a thickness of 0.5 mm, between the baseplate 1 and the faceplate 2 is only provided with a hot melt film 4 used as adhesive, a decorative film 5 of resin varnish type is provided on a surface of the faceplate 2 through rolling coating process. In this embodiment, the baseplate 1 and the faceplate 2 are formed by coiled sheet of aluminum having a thickness of 0.5 mm, so that they not only have good corrosion resistance and plasticity, but also have advantages over a signal layer aluminum panel having identical thickness therewith in physical characteristics and decorativeness.

In addition, with reference to FIG. 1, a decorative composite metal panel according to a third embodiment of the present invention is explained as follow. The decorative composite metal panel of the third embodiment is of a laminate structure, comprising a baseplate 1 and a faceplate 2, the baseplate 1 and the faceplate 2 are formed by coiled sheet of aluminum having a thickness of 0.1 mm, an intermediate plate 3 formed by high foaming polyvinyl chloride sheet having a thickness of 2.0 mm is provided between the baseplate 1 and the faceplate 2, hot melt films 4 used as adhesive are provided between the baseplate 1 and the intermediate plate 3 and between the baseplate 1 and the intermediate plate 3 respectively, a decorative film 5 of resin varnish type is provided on a surface of the faceplate 2 through rolling coating process. In this embodiment, the baseplate 1 and the faceplate 2 are formed by coiled sheet of aluminum having a thickness of 0.1 mm, and having good corrosion resistance and plasticity. The intermediate plate 3 is formed by high foaming polyvinyl chloride sheet having a thickness of 2.0 mm, and having lower density, sound and heat proofing properties, so that the resultant laminate composite panel can be used as decorative materials such as ceiling and suspended ceiling.

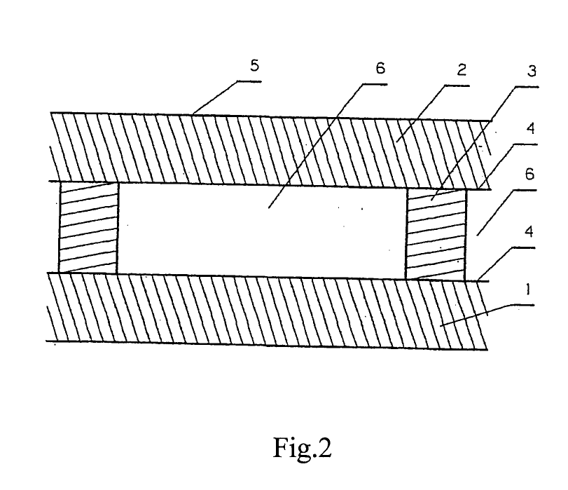

With reference to FIG. 2, a decorative composite metal panel according to a fourth embodiment of the present invention is explained as follow. The decorative composite metal panel of the fourth embodiment having a porous intermediate plate is of a laminate structure, comprising a baseplate 1 and a faceplate 2, the baseplate 1 and the faceplate 2 are formed by coiled sheet of aluminum having a thickness of 0.6 mm, an intermediate plate 3 formed by coiled sheet of aluminum having a thickness of 0.8 mm is provided between the baseplate 1 and the faceplate 2, hot melt films 4 used as adhesive are provided between the baseplate 1 and the intermediate plate 3 and between the baseplate 1 and the intermediate plate 3 respectively, a decorative film 5 of resin varnish type is provided on a surface of the faceplate 2 through rolling coating process. The intermediate plate 3 is a porous plate provided uniformly with vertical circular holes 6 thereon. Each one of the circular holes 6 has a diameter of 2.5 mm, the distance between the centers of arbitrarily two adjacent circular holes 6 is 3 mm.

The baseplate 1 and the faceplate 2 are formed by coiled sheet of aluminum having a thickness of 0.6 mm, and having good corrosion resistance and plasticity, the decorative film 5 of resin varnish type is smooth, having no chromatic aberration but with good decorativeness. The intermediate plate 3 is a porous plate made of coiled aluminum sheet having a thickness of 0.8 mm, so that its porosity is large, its weight and consumption of the aluminum are reduced, thus having improved specific strength, specific rigidity, sound and heat insulation performance.

Therefore, the present invention has simple structure, thus having an increased decorativeness and performance, so that the composite panel of the present invention is easy to be used.

Although a few embodiments of the present invention have been shown and described, it will be appreciated by those skilled in the art that changes may be made in these embodiments without departing from the principles and spirit of the invention, the scope of which is defined by the appended claims and their equivalents.

1. A decorative composite metal panel which is of a laminate structure, comprising:
a baseplate made of thin metal sheet;
a faceplate made of thin metal sheet and provided with a decorative film on a surface thereof; and
adhesive layers provided between the baseplate and the faceplate.

2. The decorative composite metal panel according to the claim 1, wherein further composing an intermediate plate disposed between said baseplate and said faceplate.

3. The decorative composite metal panel according to the claim 1 or 2, wherein each of said adhesive layers is a hot melt film.

4. The decorative composite metal panel according to the claim 1 or 2, wherein said intermediate plate is of one or a plurality of layers.

5. The decorative composite metal panel according to the claim 3, wherein said intermediate plate is of one or a plurality of layers.

6. The decorative composite metal panel according to the claim 4, wherein said intermediate plate is provided with holes thereon.

7. The decorative composite metal panel according to the claim 5, wherein said intermediate plate is provided with holes thereon.

8. The decorative composite metal panel according to the claim 6 or 7, wherein said holes are vertical holes.

9. The decorative composite metal panel according to the claim 6 or 7, wherein said holes are provided uniformly on the intermediate plate.

10. The decorative composite metal panel according to any one of the claim 1, 2, 5, 6 and 7, wherein said baseplate and said faceplate are of thin metal sheets respectively.

11. The decorative composite metal panel according to any one of the claims 2, 5, 6 and 7, wherein said intermediate plate is of metal sheet or thermoplastic resin sheet.

12. The decorative composite metal panel according to the claim 10, wherein each of said thin metal sheets forming said baseplate and said faceplate has a thickness of 0.08-1.00 mm.

13. The decorative composite metal panel according to the claim 11, wherein said intermediate plate is of thin metal sheet having a thickness of 0.08-2.00 mm or thermoplastic resin sheet having a thickness of 1.5-6.0 mm.

14. The decorative composite metal panel according to any one of the claims 6, 7 and 13, wherein said holes provided uniformly on said intermediate plate are circular, and each of said holes has a diameter of 1.0-5.0 mm.

15. The decorative composite metal panel according to any one of the claims 6, 7 and 13, wherein a distance between centers of arbitrarily two adjacent circular holes is within a range of 1.5-6.0 mm.

16. The decorative composite metal panel according to any one of the claims 1, 2, 5, 6, 7, 12 and 13, wherein said faceplate is provided with a decorative film on a surface thereof.
